(19) United States
(12) Patent Application Publication
(10) Pub. No.: US 2006/0241909 A1
(43) Pub. Date: Oct. 26, 2006

(54) System review toolset and method

(75) Inventors: Gabriel Morgan, Redondo Beach, CA (US); David Chandra, Chatswood (AU); James Whittred, Mount Ommaney (AU)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/112,825

(22) Filed: Apr. 21, 2005

(51) Int. Cl. G06F 15/00

(52) U.S. Cl. 702/183

(57) ABSTRACT

A method and toolset to conduct system review activities. The toolset may include a set of quality attributes for analysis of the system. For each quality attribute, a set of characteristics defining the attribute is provided. At least one external reference tool associated with at least a portion of the quality attributes and a deliverable template including a format are also provided. A method includes the steps of: selecting a set of quality attributes each having at least one aspect for review; reviewing a system according to defined characteristics of the attribute; and providing a system deliverable analyzing the system according to the set of quality attributes.

### BACKGROUND OF THE INVENTION

1. Field of the Invention

The present invention is directed to a method and system for providing an analysis of business and computing systems, including software and hardware systems.

2. Description of the Related Art

Consulting organizations are often asked to perform system review activities to objectively assess and determine the quality of a system. Currently, there are several approaches used in consulting agencies with no common approach or methodology designed to consistently deliver a system review and return the ‘lessons learned’ from the review activity.

The ability to consistently deliver high quality service would provide better system reviews, since system owners would know what to expect from the review and what will form the basis of the review. A consistent output from the review process enables consultants to learn from past reviews and develop better reviews in the future.

A mechanism which enables consistent reviews would therefore be beneficial.

### SUMMARY OF THE INVENTION

The present invention, roughly described, pertains to a method and toolset to conduct system review activities.

In one aspect the invention is a toolset for performing a system analysis. The toolset may include a set of quality attributes for analysis of the system. For each quality attribute, a set of characteristics defining the attribute is provided. At least one external reference tool associated with at least a portion of the quality attributes and a deliverable template including a format may also be provided.

The set of quality attributes may include at least one of the set of attributes including: System To Business Objectives Alignment; Supportability; Maintainability; Performance; Security; Flexibility; Reusability; Scalability; Usability; Testability; Alignment to Packages; or Documentation.

In another aspect, a method for performing a system analysis is provided. The method includes the steps of: selecting a set of quality attributes each having at least one aspect for review; reviewing a system according to defined characteristics of the attribute; and providing a system review deliverable analyzing the system according to the set of quality attributes.

In a further aspect, a method for creating a system analysis deliverable is provided. The method includes the steps of: positioning a system analysis by selecting a subset of quality attributes from a set of quality attributes, each having a definition and at least one characteristic for evaluation; evaluating the system by examining the system relative to the definition and characteristics of each quality attribute in the subset; generating a report reflecting the system analysis based on said step of evaluating; and modifying a characteristic of a quality attribute to include at least a portion of said report.

The present invention can be accomplished using any of a number of forms of documents or specialized application programs implemented in hardware, software, or a combination of both hardware and software. Any software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 depicts a method for performing a system review in accordance with the present invention.

FIG. 2 depicts a method for performing a positioning step.

FIG. 3 depicts a method for performing a review process.

FIG. 4 is a block diagram illustrating a toolset provided in accordance with the present invention in document form.

FIG. 5 is a block diagram illustrating a toolset provided in accordance with the present invention in a browser accessible format.

FIG. 6 is a block diagram illustrating a toolset provided in accordance with the present invention in an application program.

FIGS. 7A and 7B illustrate an exemplary deliverable template provided in accordance with the present invention.

FIG. 8 depicts a method for providing feedback in accordance with the method of FIG. 1.

FIG. 9 depicts a first mechanism for providing feedback to a toolkit owner.

FIG. 10 depicts a second mechanism for providing feedback to a toolkit owner.

FIG. 11 illustrates a processing device suitable for implementing processing devices described in the present application.

### DETAILED DESCRIPTION

The invention includes a method and toolset to conduct system review activities by comparing a system to a defined set of defined quality attributes and based on these attributes, determine how well the system aligns to a defined set of best practices and the original intent of the system. The toolset may be provided in any type of document, including a paper document, a Web based document, or other form of electronic document, or may be provided in a specialized application program running on a processing device which may be interacted with by an evaluator, or as an addition to an existing application program, such as a word processing program, or in any number for forms.

In one aspect, the system to be reviewed may comprise a software system, a hardware system, a business process or practice, and/or a combination of hardware, software and business processes. The invention addresses the target environment by applying set of predefined system tasks and attributes to the environment to measure the environment's quality, and utilizes feedback from prior analyses to grow and supplement the toolset and methodology. The toolset highlights areas in the target environment that are not aligned with the original intention of the environment and/or best practices. The toolset contains instructions for positioning the review, review delivery, templates for generating the review, and productivity tools to conduct the system review activity. Once an initial assessment is made against the attributes themselves, the attributes and content of subsequent reviews can grow by allowing implementers to provide feedback.

The method and toolset provide a simple guide to system review evaluators to conduct a system review and capture the learning back into the toolset. After repeated system reviews, the toolset becomes richer, with additional tools and information culled from past reviews adding to new reviews. The toolset provides common terminology and review area to be defined, so that technology specific insights can be consistently captured and re-used easily in any system review.

One aspect of the toolset is the ability to allow reviewers to provide their learning back into the toolset data store. This is accomplished through a one-click, context-sensitive mechanism embedded within the toolset. When the reviewer provides feedback via this mechanism, the toolset automatically provides default context-sensitive information such as; current system quality attribute, date and time, document version and reviewer name.

Software quality definitions from a number of information technology standards organizations such as the Software Engineering Institute (SEI), The Institute of Electrical and Electronics Engineers (IEEE) and the International Standards Organization (ISO) are used.

The method and toolset provides a structured guide for consulting engagements. These quality attributes can be applied to application development as well as infrastructure reviews. The materials provided in the toolset assists in the consistent delivery of a system review activity.

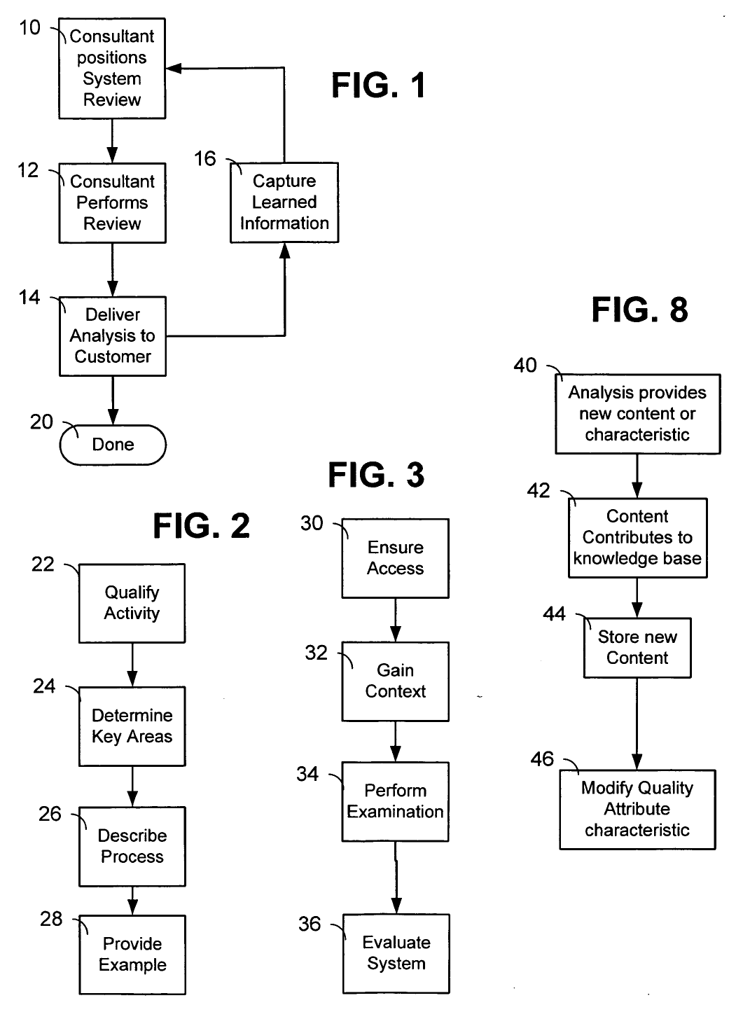

FIG. 1 is a flowchart illustrating the method of performing a review using the method and toolset of the present invention. At step 10, the review activity is positioned. Positioning involves determining if the system review activity is correctly placed for the system owner. To do this, the evaluator must make sure that the purpose of performing a system review is shared by the system owner. In the context of the toolset, the purpose of performing a system review is to determine the level of quality for a system as it aligns to a defined ‘best practice’. The term “best practice” refers to those practices that have produced outstanding results in another situation and that could be adapted for a present situation. Although a “best practice” may vary from situation to situation, there are a number of design practices that are proven to work well to build high quality systems.

In business management, a best practice is a generally accepted “best way of doing a thing”. A best practice is formulated after the study of specific business or organizational case studies to determine the most broadly effective and efficient means of organizing a system or performing a function. Best practices are disseminated through academic studies, popular business management books and through “comparison of notes” between corporations.

In software engineering the term is used similarly to business management, meaning a set of guidelines or recommendations for doing something. In medicine, best practice refers to a specific treatment for a disease that has been judged optimal after weighing the available outcome evidence.

In one embodiment, the defined best practices are those defined by a particular vendor of hardware or software. For example, if a system owner has created a system where a goal is to integrate with a particular vendor's products and services, the best practices used may be defined as those of the vendor in interacting with its products.

One example of a best practices framework is the Microsoft Solutions Framework (MSF) which provides people and process guidance to teams and organizations. MSF is a deliberate and disciplined approach to technology projects based on a defined set of principles, models, disciplines, concepts, guidelines, and proven practices.

Positioning is discussed further with respect to FIG. 2.

Next, at step 12, the evaluator must identify which quality attributes to cover in the review and perform the review. In this step the evaluator determines and comes to an agreement with the system owner on the areas to be reviewed and priority that will be covered by the review. In one embodiment, the toolset provides a number of system attributes to be reviewed, and the evaluator's review is on a subset of such attributes suing the guidelines of the toolset. The toolset provides descriptive guidance to the areas of the system to review.

Next, at step 14, the evaluator creates deliverables of the review activity. Different audiences require different levels of information. The toolset provides effective and valuable system reviews which target the information according to the intended audience. The materials provided in the toolset allow the shaping of the end deliverable for specific audiences such as CTO's, business owners or it management as well as developers and solution architects. A deliverables toolset template provides a mechanism for creating deliverables ready for different audiences of system owners.

Finally, at step 16, the learning and knowledge is captured and added to the toolset to provide value to the toolset's next use. It should be understood that step 16 may reflect two types of feedback. One type of feedback may result in modifying the characteristics of the quality attributes defined in the toolset. In this context, the method of step 16 incorporates knowledge gained about previous evaluations of systems of similar types, recognizes that the characteristic may be important for valuation of subsequent systems, and allows modification of the toolset quality attributes based on this input. A second type of feedback includes incorporating sample content from a deliverable. As discussed below with respect to FIG. 8, analysis which provide insight for common problems may yield content that is suitable for re-use. Such content can be stored in a relationship with the toolset template for access by reviewers preparing a deliverable at step 14.

FIG. 2 details the process of positioning the system review activity (step 10 above). The positioning process sets an expectation with the system owner to ensure that the toolset accurately builds a deliverable to meet the system owner's expectation.

At step 22, the first step in positioning the system review activity is to discuss the goal of the system review. Within the context of the Toolset, the purpose of performing a system review activity is to derive the level of quality. The level of quality is determined by reviewing system areas and comparing them to a ‘best practice’ for system design.

Step 22 of qualifying the system review activity may involve discussing the purpose of the system review activity with the system owner. Through this discussion, an attempt will be made to drive what caused the system owner to request a system review. Typical scenarios that prompt a system owner for a system review include: determining whether the system is designed for the future with respect to certain technology; determining whether the system appropriately uses defined technology to implement design patterns; and/or determining if the system is built using a defined ‘best practice’.

Next, at step 24, the evaluator determines key areas to cover in the system review. The goal of this step is to flush out any particular areas of the solution where the system owner feels unsure of the quality of the system.

In accordance with one embodiment of the present invention, a defined set of system attributes are used to conduct the system review. In one embodiment, the attributes for system review include:
System To Business Objectives Alignment
Supportability
Maintainability
Performance
Security
Flexibility
Reusability
Scalability
Usability
Reliability
Testability
Test Environment
Technology Alignment
Documentation

Each attribute is considered in accordance with well defined characteristics, as described in further detail for each attribute below. While in one embodiment, the evaluator could review the system for each and every attribute, typically system owners are not willing to expend the time, effort and money required for such an extensive review. Hence, in a unique aspect of the invention, for each attribute, at step 24, the evaluator may have the system owner assign a rating for each quality attribute based on a rating table for which is the system owner's best guess to the state of the existing system. Table 1 illustrates an exemplary rating table:

| Rating | | |
|---|---|---|
| Value | Rating Title | Rating Description |
| 0 | Non- | The system does not achieve this quality attribute |
| | functional | to support the business requirements. |
| 1 | Adequate | The system functions appropriately but without |
| | | any ‘best practice’ alignment. |
| 2 | Good | The system functions appropriately but marginally |
| | | demonstrates alignment to ‘best practice’. |
| 3 | Best Practice | The system functions appropriately and |
| | | demonstrates close alignment to ‘best practice’. |

The result of this exercise is a definition of the condition the system is expected to be in. This is useful as it allows for a comparison of where the system owner believes the system is in versus what the results of the review activity deliver.

In addition, step 24 defines a subset of attributes which will be reviewed by the evaluator in accordance with the invention. This is provided according to the system owner's ratings and budget.

Next, at step 26, the process of review as defined by the toolset is described to the system owner. This step involves covering each system area identified in step 24 and comparing those areas to a defined ‘best practice’ for system design supported by industry standards.

Finally, at step 28, an example review is provided to the system owner as a means of ensuring that the system owner will be satisfied with the end deliverable.

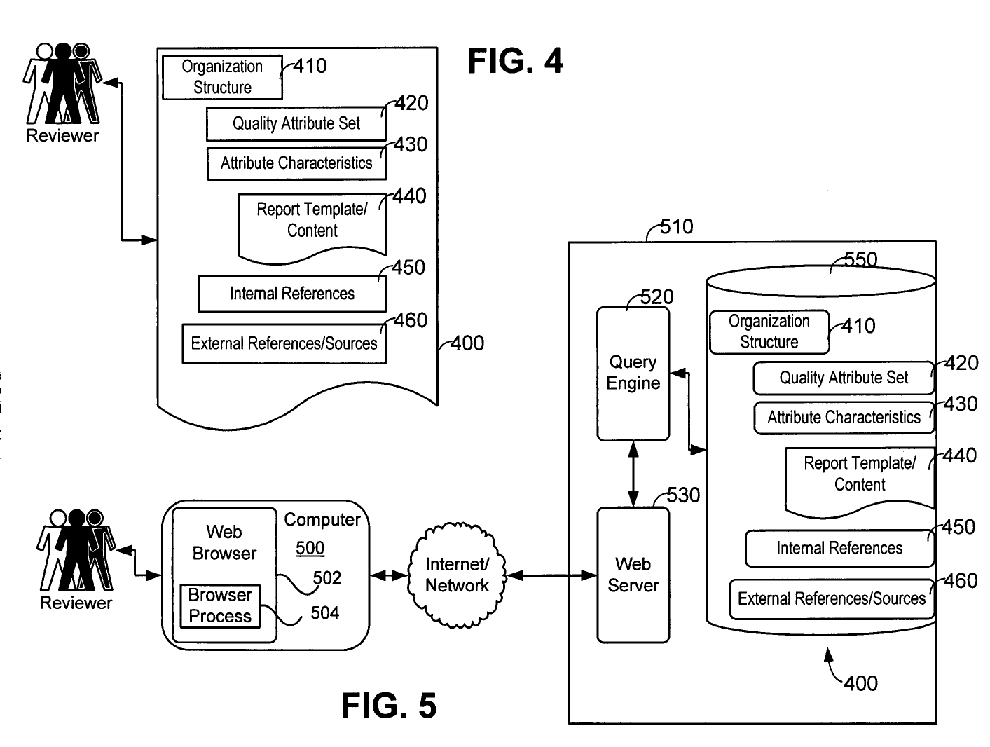

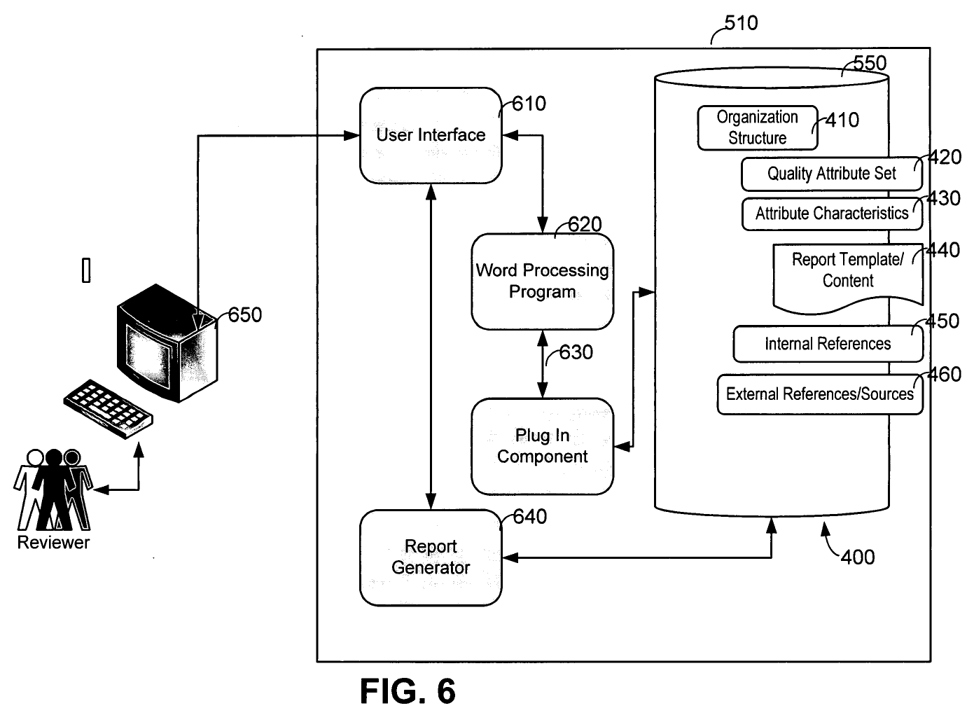

FIG. 3 shows a method for performing a system review in accordance with the present invention. As noted above, the method utilizes a toolset comprising a set of quality attributes and characteristics which guide an evaluator and which may take many forms. Exemplary forms of the toolset are illustrated in FIGS. 4-6. FIG. 4 illustrates the toolset as a document. FIG. 5 illustrates the toolset as a set of data stored in a data structure and accessible via a web browser. FIG. 6 illustrates the toolset configured as a stand-alone application or a plug-in to an existing application.

A “system review” is a generic definition that encompasses application and infrastructure review. All systems exhibit a certain mix of attributes (strength and weaknesses) as the result of various items such as the requirements, design, resource and capabilities. The approach used to perform a system review in accordance with the present invention is to compare a system to a defined set or subset of quality attributes and based on these attributes to determine how well the system aligns to defined best practices. While software metrics provide tools to make assessments as to whether the software quality requirements are being met, the use of metrics does not eliminate the need for human judgment in software assessment. The intention of the review is to highlight areas that are not aligned with the original intention of the system along with the alignment with best practices.

Returning to FIG. 3, the process of conducting a system review begins at step 30 ensuring access and availability of system information. Before executing a system review activity, the evaluator ensures that the system owner is prepared for the review. The evaluator should ensure access to: the functional requirements of the system; the non-functional requirements of the system; the risks and issues for the system; any known issues of the system; system documentation which describes the system conceptual and logical design; application source code, if conducting system development reviews; documentation of the system's operating environment such as a network topology, such as data flow diagrams, etc; the developers or system engineers familiar with the system; the business owners of the system; the operational owners of the system; and relevant tools required to assist the review such as system analysis tools.

Next, at step 32, the evaluator should gain contextual information through reviewing the system's project documentation to understand the background surrounding the system. The system review can be more valuable to the client by understanding the relevant periphery information such as the purpose of the system from the business perspective.

Next, at step 34, the system is examined using all or the defined subset of the toolset quality attributes. Quality attributes are used to provide a consistent approach in observing systems regardless of the actual technology used. A system can be reviewed at two different levels: design and implementation. At the design level, the main objective is to ensure the design incorporates the required attribute at the level specified by the system owner. Design level review concentrates more on the logical characteristics of the system. At the implementation level, the main objective is to ensure the way the designed system is implemented adheres to best practices for the specific technology. For application review this could mean performing code level reviews for specific areas of the application as well as reviewing the way the application will be deployed and configured. For infrastructure reviews this could mean conducting a review of the way the software should be configured and distributed across different servers.

In some contexts, when a defined business practice or practice framework is known before planning the system, a design level review can start as early as the planning phase.

Finally, at step 36, the evaluator reviews each of the set or subset of quality attributes relative to the system review areas based on the characteristics of each attribute.

FIG. 4 shows a first example of the toolset of the present invention. The toolset is provided in a document 400 and includes an organizational structure 410 defined by the elements 420, 430, 440, 450 and 460. The structure includes a quality attribute set 420, each attribute including a standardized, recognized definition, a set of characteristics 430 associated with each attribute to be evaluated, report templates and sample content 440, internal reference tools 450 and external reference tools 460. The quality attributes define the evaluation, as discussed above and for each attribute, a set of characteristics comprising the attribute define the individual evaluations a reviewer should conduct. The report templates 440 include a sample deliverables document along with content captured in previous analyses provided at step 16 described above. The content may take the form of additional documents or paragraphs organized in a manner similar to the task selection template in order to make it easy for the evaluator to include the information in their analysis. Internal 450 and external 460 tools and tool references may include reference books, papers, hyperlinks or applications designed to provide additional information on the quality attribute under consideration to the evaluator.

FIG. 5 shows a second embodiment of the toolset wherein the toolset 400 is provided in one or more data stores 550 accessible by a standard web browser 502 running on a client computer 500. In this embodiment, the data incorporated into the toolset 400 is provided to the data store 550. The data may be formatted as a series of documents, including for example, HTML documents, which can be rendered on a web browser 502 in a standard browser process. Optionally, a server 510 includes a web server service 530 which may render data from the toolset 400 to the web browser 502 in response to a request from a reviewer using the computer 500. It will be understood that the data in data store need not be accessed by a web server in the case where a review uses a computing device 500 accessing the data via a network an the data 400 is stored directly on, for example, a file server coupled to the same network as the computing device 500. It should be understood that device 500 and device 510 may communicate via any number of local or global area networks, including the Internet. Optionally a query engine 520 may be provided to implement searches, such as key word searches, on the toolset data 400.

FIG. 6 shows yet another embodiment of the toolset wherein the toolset is provided as a stand alone application or a component of another application. In this embodiment, the toolset 400 is provided in a data store 550, which is accessed by an application 640 such as a report generator which allows access to the various elements of toolset 400 and outputs a deliverable in accordance with the deliverable described herein. In an alternative embodiment, the toolset or various components thereof may be made available through an application plug-in component 630 to an existing commercial application 620 which is then provided to a user interface rendering component 610.

One example of a quality attributes and characteristics, provided in an attribute/characteristic hierarchy, is provided as follows:

Quality Attributes:

1.1 System Business Objectives Alignment
1.1.1 Vision Alignment
   1.1.1.1 Requirements to System Mapping
1.1.2 Desired Quality Attributes

1.2 Supportability
1.2.1 Technology Maturity
1.2.2 Operations Support
   1.2.2.1 Monitoring
      1.2.2.1.1 Instrumentation
   1.2.2.2 Configuration Management
   1.2.2.3 Deployment Complexity
   1.2.2.4 Exception Management
      1.2.2.4.1 Exception Messages
      1.2.2.4.2 Exception Logging
      1.2.2.4.3 Exception Reporting

1.3 Maintainability
1.3.1 Versioning
1.3.2 Re-factoring
1.3.3 Complexity
   1.3.3.1 Cyclomatic Complexity
   1.3.3.2 Lines of code
   1.3.3.3 Fan-out
   1.3.3.4 Dead Code
1.3.4 Code Structure
   1.3.4.1 Layout
   1.3.4.2 Comments and Whitespace
   1.3.4.3 Conventions

1.4 Performance
1.4.1 Code optimizations
   1.4.1.1 Programming Language Functions Used
   1.4.2 Technologies used
1.4.3 Caching
   1.4.3.1 Presentation Layer Caching
   1.4.3.2 Business Layer Caching
   1.4.3.3 Data Layer Caching

1.5 Security
1.5.1 Network
   1.5.1.1 Attack Surface
   1.5.1.2 Port Filtering
   1.5.1.3 Audit Logging
1.5.2 Host
   1.5.2.1 Least Privilege
   1.5.2.2 Attack Surface
   1.5.2.3 Port Filtering
   1.5.2.4 Audit Logging
1.5.3 Application
   1.5.3.1 Attack Surface
   1.5.3.2 Authorisation
      1.5.3.2.1 Least Privilege
      1.5.3.2.2 Role-based
      1.5.3.2.3 ACLs
      1.5.3.2.4 Custom
   1.5.3.3 Authentication
   1.5.3.4 Input Validation
   1.5.3.5 Buffer Overrun
   1.5.3.6 Cross Site Scripting
   1.5.3.7 Audit Logging
1.5.4 Cryptography
   1.5.4.1 Algorithm Type used
   1.5.4.2 Hashing used
   1.5.4.3 Key Management
1.5.5 Patch Management
1.5.6 Audit

1.6 Flexibility
1.6.1 Application Architecture
   1.6.1.1 Architecture Design Patterns
      1.6.1.1.1 Layered Architecture
   1.6.1.2 Software Design Patterns
      1.6.1.2.1 Business Facade Pattern
      1.6.1.2.2 Other Design Pattern

1.7 Reusability
1.7.1 Layered Architecture
1.7.2 Encapsulated Logical Component Use
1.7.3 Service Oriented Architecture
1.7.4 Design Pattern Use

1.8 Scalability
1.8.1 Scale up
1.8.2 Scale out
   1.8.2.1 Load Balancing
1.8.3 Scale Within

1.9 Usability
1.9.1 Learnability
1.9.2 Efficiency
1.9.3 Memorability
1.9.4 Errors
1.9.5 Satisfaction

1.10 Reliability
1.101 Server Failover Support
1.10.2 Network Failover Support
1.10.3 System Failover Support
1.10.4 Business Continuity Plan (BCP) Linkage
   1.10.4.1 Data Loss
   1.10.4.2 Data Integrity or Data Correctness

1.11 Testability
1.11.1 Test Environment and Production Environment Comparison
1.11.1 Unit Testing
1.11.2 Customer Test
1.11.3 Stress Test
1.11.4 Exception Test
1.11.5 Failover
1.11.6 Function
1.11.7 Penetration
1.11.8 Usability
1.11.9 Performance
1.11.10 User Acceptance Testing
1.11.11 Pilot Testing
1.11.12 System
1.11.13 Regression
1.11.14 Code Coverage

1.12 Technology Alignment
1.13 Documentation
1.13.1 Help and Training
1.13.2 System-specific Project Documentation
   1.13.2.1 Functional Specification
   1.13.2.2 Requirements
   1.13.2.3 Issues and Risks
   1.13.2.4 Conceptual Design
   1.13.2.5 Logical Design
   1.13.2.6 Physical Design
   1.13.2.7 Traceability
   1.13.2.8 Threat Model

For each of the quality attributes listed in the above template, the toolset provides guidance to the evaluator in implementing the system review in accordance with the following description. In accordance with the invention, certain external references and tools are listed. It will be understood by one of average skill in the art that such references are exemplary and not exhaustive of the references which may be used by the toolset.

A first of the quality attributes is System Business Objectives Alignment. This attribute includes the following characteristics for evaluation:

1.1 System Business Objectives Alignment
1.1.1 Vision Alignment
   1.1.1.1 Requirements to System Mapping
1.1.2 Desired Quality Attributes

Evaluating System Business Objectives Alignment involves evaluating vision alignment and desired quality attributes. Vision alignment involves understanding the original vision of the system being reviewed. Knowing the original system vision allows the reviewer to gain better understanding of what to expect of the existing system and also what the system is expected to be able to do in the future. Every system will have strengths in certain quality attributes and weaknesses in others. This is due to practical reasons such as resources available, technical skills and time to market.

Vision alignment may include mapping requirements to system implementation. Every system has a predefined set of requirements it will need to meet to be considered a successful system. These requirements can be divided into two categories: functional and non-functional. Functional requirements are the requirements that specify the functionality of the system in order to provide useful business purpose. Non-functional requirements are the additional generic requirements such as the requirement to use certain technology, criteria to deliver the system within a set budget etc. Obtaining these requirements and understanding them for the review allows highlighting items that need attention relative to the vision and requirements.

A second aspect of system business objectives alignment is determining desired quality attributes. Prioritizing the quality attributes allows specific system designs to be reviewed for adhering to the intended design. For example, systems that are intended to provide the best possible performance and do not require scalability have been found to be designed for scalability with the sacrifice of performance. Knowing that performance is a higher priority attribute compared to scalability for this specific system allows the reviewer to concentrate on this aspect.

A second quality attribute evaluated may be Supportability. Supportability is the ease with which a software system is operationally maintained. Supportability involves reviewing technology maturity and operations support. This attribute includes the following characteristics for evaluation:

1.2 Supportability
1.2.1 Technology Maturity
1.2.2 Operations Support
   1.2.2.1 Monitoring
      1.2.2.1.1 Instrumentation
   1.2.2.2 Configuration Management
   1.2.2.3 Deployment Complexity
   1.2.2.4 Exception Management
      1.2.2.4.1 Exception Messages
      1.2.2.4.2 Exception Logging
      1.2.2.4.3 Exception Reporting

A first attribute of supportability is technology maturity. Technology always provides a level of risk in any system design and development. The amount of risk is usually related to the maturity of the technology; the longer the technology has been in the market the less risky it is because it has gone through more scenarios. However, new technologies can provide significant business advantage through increased productivity or allowing deeper end user experience that allows the system owner to deliver more value to their end user.

This level of analysis involves the reviewer understanding the system owner's technology adoption policy. Business owners may not know the technologies used and what stage of the technology cycle they are in. The reviewer should highlight any potential risk that is not in compliance with the system owner's technology adoption policy. Typical examples include: technologies that are soon to be decommissioned or are too ‘bleeding edge’ that could add risk to the supportability and development/deployment of the system.

Another aspect of supportability is operations support. Operations support involves system monitoring, configuration management, deployment complexity and exception management. Monitoring involves the reviewer determining if the monitoring for the system is automated with a predefined set of rules that map directly to a business continuity plan (BCP) to ensure that the system provides the ability to fit within an organizations support processes.

Monitoring may involve an analysis of instrumentation, configuration management, deployment complexity and exception management. Instrumentation is the act of incorporating code into one's program that reveals system-specific data to someone monitoring that system. Raising events that help one to understand a system's performance or allow one to audit the system are two common examples of instrumentation. Common technologies used for instrumentation are Windows Management Instrumentation (WMI). Ideally, an instrumentation mechanism should provide an extensible event schema and unified API which leverages existing eventing, logging and tracing mechanisms built into the host platform. For the Microsoft Windows platform, it should also include support for open standards such as WMI, Windows Event Log, and Windows Event Tracing. WMI is the Microsoft implementation of the Web-based Enterprise Management (WBEM) initiative—an industry initiative for standardizing the conventions used to manage objects and devices on many machines across a network or the Web. WMI is based on the Common Information Model (CIM) supported by the Desktop Management Taskforce (DMTF—http://www.dmtf.org/home). WMI offers a great alternative to traditional managed storage mediums such as the registry, disk files, and even relational databases. The flexibility and manageability of WMI are among its greatest strengths. External resources available for the evaluator and available as a link or component of the toolset with respect to instrumentation are listed in Table 2:

| Title | Reference Link |
|---|---|
| Enterprise | http://msdn.microsoft.com/vstudio/productinfo/enterprise/eif/ |
| Instrumentation | |
| Framework (EIF) | |
| Windows Management | http://msdn.microsoft.com/msdnmag/issues/01/09/AppLog/default.aspx |
| Instrumentation: Create | |
| WMI Providers to Notify | |
| Applications of System | |
| Events | |

Another aspect of monitoring is configuration management. This involves the evaluator determining if the system is simple to manage. Configuration management is the mechanism to manage configuration data for systems. Configuration management should provide: a simple means for systems to access configuration information; a flexible data model—an extensible data handling mechanism to use in any in-memory data structure to represent one's configuration data; storage location independence—built-in support for the most common data stores and an extensible data storage mechanism to provide complete freedom over where configuration information for systems is stored; data security and integrity—data signing and encryption is supported with any configuration data—regardless of its structure or where it is stored—to improve security and integrity; performance—optional memory-based caching to improve the speed of access to frequently read configuration data; and extensibility—a handful of simple, well-defined interfaces to extend current configuration management implementations. An external resources available for the evaluator with respect to configuration management and available as a link or component of the toolset includes : Configuration Management Application Block for NET (http://msdn.microsoft.com/library/default.asp?url=/library/en-us/dnbda/html/cmab.asp)

Deployment Complexity is the determination by the evaluator of whether the system is simple to package and deploy. Building enterprise class solutions involves not only developing custom software, but also deploying this software into a production server environment. The evaluator should determine whether deployment aligns to well-defined operational processes to reduce the effort involved with promoting system changes from development to production. External resources available for the evaluator with respect to deployment complexity and available as a link or component of the toolset are listed in Table 3:

| Title | Reference Link |
|---|---|
| Deployment Patterns | http://msdn.microsoft.com/library/default.asp?url=/library/en-us/dnpatterns/html/EspDeploymentPatterns.asp |
| Deploying .NET Web | http://www.microsoft.com/applicationcenter/techinfo/deployment/2000/wp_net.asp |
| Applications with | |
| Microsoft Application | |
| Centre | |

Another aspect of operations support is Exception Management. Good exception management implementations involve certain general principles: a system should properly detect exceptions; a system should properly log and report on information; a system should generate events that can be monitored externally to assist system operation; a system should manage exceptions in an efficient and consistent way; a system should isolate exception management code from business logic code; and a system should handle and log exceptions with a minimal amount of custom code. External resources available for the evaluator with respect to exception management and available as a link or component of the toolset are listed in Table 4:

| Title | Reference Link |
|---|---|
| Exception | http://msdn.microsoft.com/library/default.asp?url=/library/en-us/dnbda/html/exceptdotnet.asp |
| Management | |
| Architecture | |
| Guide | |
| Exception | http://msdn.microsoft.com/library/default.asp?url=/library/en-us/dnbda/html/emab-rm.asp |
| Management | |
| Application Block | |
| for .NET | |

There are three primary areas of exception management that should be reviewed: exception messages, exception logging and exception reporting. The evaluator should determine: whether exception messages captured should be appropriate for the audience; whether the event logging mechanism leverages the host platform and allows for secure transmission to a reporting mechanism; and whether the exception reporting mechanism provided is appropriate.

Another quality attribute which may be evaluated is Maintainability. Maintainability is has been defined as: The aptitude of a system to undergo repair and evolution [Barbacci, M. Software Quality Attributes and Architecture Tradeoffs. Software Engineering Institute, Carnegie Mellon University. Pittsburgh, Pa.; 2003, hereinafter “Barbacci 2003”] and the ease with which a software system or component can be modified to correct faults, improve performance or other attributes, or adapt to a changed environment or the ease with which a hardware system or component can be retained in, or restored to, a state in which it can perform its required functions. [IEEE Std. 610.12] This attribute includes the following characteristics for evaluation:

1.3 Maintainability
1.3.1 Versioning
1.3.2 Re-factoring
1.3.3 Complexity
   1.3.3.1 Cyclomatic Complexity
   1.3.3.2 Lines of code
   1.3.3.3 Fan-out
   1.3.3.4 Dead Code
1.3.4 Code Structure
   1.3.4.1 Layout
   1.3.4.2 Comments and Whitespace
   1.3.4.3 Conventions

Examples of external software tools which an evaluator may utilize to evaluate maintainability are Aivosto's Project Analyzer v7.0 http://www.aivosto.com/project/project.html and Compuware's DevPartner Studio Professional Edition: http://www.compuware.com/products/devpartner/studio.htm.

Evaluating maintainability includes reviewing versioning, re-factoring, complexity and code structure analysis. Versioning is the ability of the system to track various changes in its implementation. The evaluator should determine if the system supports versioning of entire system releases. Ideally, system releases should support versioning for release and rollback that include all system files including: System components; System configuration files and Database objects. External resources available for the evaluator with respect to maintainability and available as a link or component of the toolset are listed in Table 5:

| Title | Reference Link |
|---|---|
| .NET Framework | http://msdn.microsoft.com/library/default.asp?url=/library/en-us/cpguide/html/cpconassemblyversioning.asp |
| Developer's Guide: | |
| Assembly Versioning | |
| Deploying .NET Web | http://www.microsoft.com/applicationcenter/techinfo/deployment/2000/wp_net.asp |
| Applications with | |
| Microsoft Application | |
| Center | |

Re-factoring is defined as improving the code while not changing its functionality. [Newkirk, J.; Vorontsov, A.; Test Driven Development in Microsoft .NET. Redmond, Wash.; Microsoft Press, 2004, hereinafter “Newkirk 2004”]. The review should consider how well the source code of the application has been re-factored to remove redundant code. Complexity is the degree to which a system or component has a design or implementation that is difficult to understand and verify [Institute of Electrical and Electronics Engineers. IEEE Standard Computer Dictionary: A Compilation of IEEE Standard Computer Glossaries. New York, N.Y.: 1990, hereinafter “IEEE 90”]. Alternatively, complexity is the degree of complication of a system or system component, determined by such factors as the number and intricacy of interfaces, the number and intricacy of conditional branches, the degree of nesting, and the types of data structures [Evans, Michael W. & Marciniak, John. Software Quality Assurance and Management. New York, N.Y.: John Wiley & Sons, Inc., 1987]. In this context of the toolset, evaluating complexity is broken into the following areas: cyclomatic complexity; lines of code; fan-out; and dead code.

Cyclomatic complexity is the most widely used member of a class of static software metrics. Cyclomatic complexity may be considered a broad measure of soundness and confidence for a program. It measures the number of linearly-independent paths through a program module. This measure provides a single ordinal number that can be compared to the complexity of other programs. Cyclomatic complexity is often referred to simply as program complexity, or as McCabe's complexity. It is often used in concert with other software metrics. As one of the more widely-accepted software metrics, it is intended to be independent of language and language format.

The evaluator should determine if the number of lines of code per procedure is adequate. Ideally, procedures should not have more than 50 lines. Lines of code is calculated by the following equation: Lines of code=Total lines−Comment lines-Blank lines.

The evaluator should determine if the call tree for a component is appropriate. Fan-out is the amount a procedure makes calls to other procedures. A procedure with a high fan-out value (greater than 10) suggests that it is coupled to other code, which generally means that it is complex. A procedure with a low fan-out value (less than 5) suggests that it is isolated and relatively independent which is simple to maintain.

The evaluator should determine if there are any lines of code not used or will never be executed (dead code). Removing dead code considered an optimization of code. Determine if there is source code that is declared and not used. Types of dead code include:
Dead procedure. A procedure (or a DLL procedure) is not used or is only called by other dead procedures.
Empty Procedure. An existing procedure with no code.
Dead Types. A variable, constant, type or enum declared but not used.
Variable assigned only. A variable is assigned a value but the value is never used.
Unused project file. A project file exists such as scripts, modules, classes, etc but is not used.

Code analysis involves a review of layout, comments and white space and conventions. The evaluator should determine if coding standards are in use and followed. The evaluator should determine if the code adheres to a common layout. The evaluator should determine if the code leverages comments and white space appropriately. Comments-to-code ratio and white space-to-code ratio generally adds to code quality. The more comments in one's code, the easier it is to read and understand. These are also important for legibility. The evaluator should determine if naming conventions are adhered to. At a minimum, at one should be adopted and used consistently. External resources available for the evaluator with respect to code analysis include: Hungarian Notation (http://msdn.microsoft.com/library/default.asp?url=/library/en-us/dnvsqen/html/hunganotat.asp)

Another quality attribute for analysis is Performance. Performance is the responsiveness of the system—the time required to respond to stimuli (events) or the number of events processed in some interval of time. Performance qualities are often expressed by the number of transactions per unit time or by the amount of time it takes to complete a transaction with the system. [Bass, L.; Clements, P.; & Kazman, R. Software Architecture in Practice. Reading, Mass.; Addison-Wesley, 1998. hereinafter “Bass 98”]

1.4 Performance
1.4.1 Code optimizations
   1.4.1.1 Programming Language Functions Used
1.4.2 Technologies used
1.4.3 Caching
   1.4.3.1 Presentation Layer Caching
   1.4.3.2 Business Layer Caching
   1.4.3.3 Data Layer Caching

An external resource available for the evaluator with respect to performance and available as a link or component of the toolset includes: Performance Optimization in Visual Basic NET, (http://msdn.microsoft.com/library/default.asp?url=/library/en-us/dv_vstechart/html/vbtchperfopt.asp)

Characteristics which contribute to performance include: code optimizations, technologies used and caching the evaluator should determine where Code optimizations could occur. In particular, this includes determining whether optimal programming language functions are used. For example, using $ functions in Visual Basic to improve execution performance of an application.

The evaluator should determine if the technologies used could be optimized. For example, if the system is a Microsoft® .Net application, configuring the garbage collection or Thread Pool for optimum use can improve performance of the system.

The evaluator should determine if caching could improve the performance of a system. External resources available for the evaluator with respect to caching and available as a link or component of the toolset are listed in Table 6:

| Title | Reference Link |
|---|---|
| Caching Architecture | http://msdn.microsoft.com/library/default.asp?url=/library/en-us/dnbda/html/CachingArch.asp |
| Guide for .NET | |
| Framework | |
| Applications | |
| ASP.NET | http://msdn.microsoft.com/library/default.asp?url=/library/en-us/dnaspp/html/aspnet-cachingtechniquesbestpract.asp |
| Caching: | |
| Techniques and | |
| Best Practices | |
| Caching Architecture | http://msdn.microsoft.com/library/default.asp?url=/library/en-us/dnbda/html/CachingArchch1.asp |
| Guide for .NET | |
| Framework | |
| Applications PAG | |

Three areas of caching include Presentation Layer Caching, Business Layer Caching and Data Layer Caching. The evaluator should determine if all three are used appropriately.

Another quality attribute of a system which may be reviewed is System Security. Security is a measure of the system's ability to resist unauthorized attempts at usage and denial of service while still providing its services to legitimate users. Security is categorized in terms of the types of threats that might be made to the system. [Bass, L.; Clements, P.; & Kazman, R. Software Architecture in Practice. Reading, Mass.; Addison-Wesley, 1998.] The toolset may include a general reminder of the basic types of attacks, based on the STRIDE model, developed by Microsoft, which categorizes threats and common mitigate techniques, as reflected in Table 7:

| Classification | Definition | Common Mitigation Techniques |
|---|---|---|
| Spoofing | Illegally accessing and then using | Strong authentication |
| | another user's authentication information | |
| Tampering of | Malicious modification of data | Hashes, Message |
| data | | authentication codes, |
| | | Digital signatures |
| Repudiation | Repudiation threats are | Digital signatures, |
| | associated with users who deny | Timestamps, Audit trails |
| | performing an action without other | |
| | parties having any way to prove | |
| | otherwise | |
| Information | The exposure of information to | Strong Authentication, |
| disclosure | individuals who are not supposed | access control, Encryption, |
| | to have access to it | Protect secrets |
| Denial of | Deny service to valid users | Authentication, |
| service | | Authorization, Filtering, |
| | | Throttling |
| Elevation of | An unprivileged user gains | Run with least privilege |
| privileges | privileged access | |

This attribute includes the following characteristics for evaluation:

1.5 Security
1.5.1 Network
   1.5.1.1 Attack Surface
   1.5.1.2 Port Filtering
   1.5.1.3 Audit Logging
1.5.2 Host
   1.5.2.1 Least Privilege
   1.5.2.2 Attack Surface
   1.5.2.3 Port Filtering
   1.5.2.4 Audit Logging
1.5.3 Application
   1.5.3.1 Attack Surface
   1.5.3.2 Authorisation
      1.5.3.2.1 Least Privilege
      1.5.3.2.2 Role-based
      1.5.3.2.3 ACLs
      1.5.3.2.4 Custom
   1.5.3.3 Authentication
   1.5.3.4 Input Validation
   1.5.3.5 Buffer Overrun
   1.5.3.6 Cross Site Scripting
   1.5.3.7 Audit Logging

1.5.4 Cryptography
1.5.4.1 Algorithm Type used
1.5.4.2 Hashing used
1.5.4.3 Key Management
1.5.5 Patch Management
1.5.6 Audit

The approach taken to review system security is to address the three general areas of a system environment; network, host and application. These areas are chosen because if any of the three are compromised then the other two could potentially be compromised. The network is defined as the hardware and low-level kernel drivers that form the foundation infrastructure for a system environment. Examples of network components are routers, firewalls, physical servers, etc. The host is defined as the base operating system and services which run the system. Examples of host components are Windows Server 2003 operating system, Internet Information Server, Microsoft Message Queue, etc. The application is defined as the custom or customized application components that collectively work together to provide business features. Cryptography may also be evaluated.

External resources available for the evaluator with respect to security and available as a link or component of the toolset are listed in Table 8:

| Title | Reference Link |
|---|---|
| PAG Security: Index of | http://msdn.microsoft.com/library/default.asp?url=/library/en-us/dnnetsec/html/CL_Index_Of.asp |
| Checklists | |
| Improving Web | http://msdn.microsoft.com/library/default.asp?url=/library/en-us/dnnetsec/html/ThreatCounter.asp |
| Application Security: | |
| Threats and | |
| Countermeasures | |
| Securing one's | http://msdn.microsoft.com/library/default.asp?url=/library/en-us/dnnetsec/html/ThreatCounter.asp |
| Application Server | |
| FxCop Team Page | http://www.gotdotnet.com/team/fxcop/ |

For network level security, the evaluator should determine if there are vulnerabilities in the network layer. This includes determining where an attack might surface by determining if there are any unused ports open on network firewalls, routers, switches that can be disabled. The evaluator should also determine if port filtering is used appropriately, and if audit logging is appropriately used, such as in a security policy modification log. External resources available for the evaluator with respect to this analysis are listed in Table 9:

| Title | Reference Link |
|---|---|
| Securing one's | http://msdn.microsoft.com/library/default.asp?url=/library/en-us/secmod/html/secmod88.asp |
| Network | |
| Checklist: Securing | http://msdn.microsoft.com/library/default.asp?url=/library/en-us/dnnetsec/html/CL_SecuNet.asp |
| one's Network | |

For host level security, the evaluator should determine if the host is configured appropriately for security. This includes determining if the security identity the host services use are appropriate (Least Privilege), reducing the attack surface by determining if there are any unnecessary services that are not used; determining if port filtering is used appropriately; and determining if audit logging such as data access logging, system service usage (e.g. IIS logs, MSMQ audit logs, etc) is appropriately used.

External resources available for the evaluator with respect to application security and available as a link or component of the toolset are listed in Table 10:

| Title | Reference Link |
|---|---|
| Improving Web Application | http://msdn.microsoft.com/library/default.asp?url=/library/en-us/dnnetsec/html/ThreatCounter.asp |
| Security: Threats and | |
| Countermeasures | |
| Securing one's Application Server | http://msdn.microsoft.com/library/default.asp?url=/library/en-us/dnnetsec/html/ThreatCounter.asp |
| Checklist: Securing Enterprise | http://msdn.microsoft.com/library/default.asp?url=/library/en-us/dnnetsec/html/CL_SecuEnt.asp |
| Services | |
| Checklist: Securing one's Web | http://msdn.microsoft.com/library/default.asp?url=/library/en-us/dnnetsec/html/CL_SecWebs.asp |
| Server | |
| Checklist: Securing one's | http://msdn.microsoft.com/library/default.asp?url=/library/en-us/dnnetsec/html/CL_SecDBSe.asp |
| Database Server | |

For application level security, the evaluator should determine if the application is appropriately secured. This includes reducing the attack surface and determining if authorization is appropriately used. It also includes evaluating authentication, input validation, buffer overrun cross-site scripting and audit logging.

Determining appropriate authentication includes evaluating: if the security identity the system uses is appropriate (Least Privilege); if role-based security is required and used appropriately; if Access Control List's (ACLs) are used appropriately; if there is a custom authentication mechanism used and whether it is used appropriately. External resources available for the evaluator with respect to authentication and available as a link or component of the toolset are listed in Table 11:

| Title | Reference Link |
|---|---|
| Checklist: Securing ASP.NET | http://msdn.microsoft.com/library/default.asp?url=/library/en-us/dnnetsec/html/CL_SecuAsp.asp |
| Checklist: Security Review for | http://msdn.microsoft.com/library/default.asp?url=/library/en-us/dnnetsec/html/CL_SecRevi.asp |
| Managed Code | |
| Designing Application-Managed | http://msdn.microsoft.com/library/?url=/library/en-us/dnbda/html/damaz.asp |
| Authorization | |
| Checklist: Securing Web Services | http://msdn.microsoft.com/library/default.asp?url=/library/en-us/dnnetsec/html/CL_SecuWeb.asp |

System authentication mechanisms are also evaluated. The evaluator should determine if the authentication mechanism(s) are use appropriately. There are circumstances where simple but secure authentication mechanisms are appropriate such as Directory Service (e.g. Microsoft Active Directory) or where a stronger authentication mechanism is appropriate such as using a multifactor authentication mechanisms, for example, a combination of biometrics and secure system authentication such as two-form or three-form authentication. There are number of types of authentications mechanisms.

In addition, the evaluator should determine if all input is validated. Generally, regular expressions are useful to validate input. The evaluator should determine if the system is susceptible to buffer overrun attacks. Finally with respect to application authentication, the evaluator should determine if the system writes web form input directly to the output without first encoding the values, (for example, whether the system should use the HttpServerUtility.HtmlEncode Method in the Microsoft® .Net Framework.). Finally, the evaluator should determine if the system appropriately uses application-level audit logging such as: logon attempts—by capturing audit information if the system performs authentication or authorization tasks; and CRUD transactions—by capturing the appropriate information if the system performs and create, update or delete transactions.

In addition to network, host and application security, the evaluator may determine if the appropriate encryption algorithms are used appropriately. That is, based on the appropriate encryption algorithm type (symmetric v asymmetric), determine whether or not hashing is required (e.g. SHA1, MD5, etc), which cryptography algorithm is appropriate (e.g. 3DES, RC2, Rajndael, RSA, etc) and for each of these, what best suits the system owner environment. This may further include: determining if the symmetric/asymmetric algorithms are used appropriately; and determining if hashing is required and used appropriately; determining if key management as well as ‘salting’ secret keys is implemented appropriately.

Two additional areas which may be evaluated are patch management and system auditing. The evaluator should determine whether such systems and whether they are used appropriately.

Another quality aspect which may be evaluated is Flexibility. Flexibility is the ease with which a system or component can be modified for use in applications or environments other than those for which it was specifically designed. [Barbacci, M.; Klien, M.; Longstaff, T; Weinstock, C. Quality Attributes—Technical Report CMU/SEI-95-TR-021 ESC-TR-95-021. Carnegie Mellon Software Engineering Institute, Pittsburgh, Pa.; 1995, hereinafter “Barbacci 1995”]. The flexibility quality attribute includes the following evaluation characteristics:

1.6 Flexibility
1.6.1 Application Architecture
   1.6.1.1 Architecture Design Patterns
      1.6.1.1.1 Layered Architecture
   1.6.1.2 Software Design Patterns
      1.6.1.2.1 Business Facade Pattern
      1.6.1.2.2 Other Design Pattern

The evaluation of system flexability generally involves determining if the application architecture provides a flexible application. That is, a determination of whether the architecture can be extended to service other devices and business functionality. The evaluator should determine if design patterns are used appropriately to provide a flexible solution. External resources available for the evaluator with respect to this evaluation and available as a link or component of the toolset are listed in Table 12:

| Title | Reference Information |
|---|---|
| Three-Layer | http://msdn.microsoft.com/library/default.asp?url=/library/en-us/dnpatterns/html/ArcLayeredApplication.asp |
| Architecture | |
| Service-Oriented | http://msdn.microsoft.com/library/default.asp?url=/library/en-us/dnpag/html/ArchServiceOrientedIntegration.asp |
| Integration | |

The evaluator should determine if the application adheres to a layered architecture design and if the software design provides a flexible application. External resources available for the evaluator with respect to this evaluation include Design Patterns, Elements of Reusable Object-Oriented Software, Gamma, E.; Helm, R; Johnson, R.; & Vlissides, J. Design Patterns, Elements of Reusable Object-Oriented Software. Addison-Wesley, 1995. Carnegie Mellon Software Engineering Institute , hereinafter “Gamma 95”.

The evaluator should determine if the business facade pattern is used appropriately. [Gamma 95] and also if the solution provides flexibility through use of common design patterns such as for example Command Patter and Chain of Responsibility. [Gamma 95].

Another quality aspect which may be evaluated is Reusability. Reusability is the degree to which a software module or other work product can be used in more than one computing program or software system. [IEEE 90]. This is typically in the form reusing software that is an encapsulated unit of functionality.

This attribute includes the following characteristics for evaluation:

1.7 Reusability
1.7.1 Layered Architecture
1.7.2 Encapsulated Logical Component Use
1.7.3 Service Oriented Architecture
1.7.4 Design Pattern Use

Reusability involves evaluation of whether the system uses a layered architecture, encapsulated logical component use, is a service oriented architecture, and design pattern use. The evaluator should determine if the application is appropriately layered, and encapsulates components for easy reuse. If a Service Oriented Architecture (SOA) as a goal was implemented, the evaluator should determine if the application adheres to the four SOA tenets: boundaries are explicit; services are autonomous; services share schema and contract, not class and service compatibility is determined based on policy. [URL: http://msdn.microsoft.com/msdnmag/issues/04/01/Indigo/hereinafter “Box 2003”]

An external resource available for the evaluator with respect to instrumentation include: A Guide to Developing and Running Connected Systems with Indigo, http://msdn.microsoft.com/msdnmag/issues/04/01/Indigo/

| | |
|---|---|
| Title | Reference Information |

The evaluator should determine if common design patterns such as the business facade or command pattern are in use and used appropriately. [Gamma 95]

Another quality aspect which may be evaluated is Scalability. Scalability is the ability to maintain or improve performance while system demand increases. Typically, this is implemented by increasing the number servers or server resources. This attribute includes the following characteristics for evaluation:

1.8 Scalability
1.8.1 Scale up
1.8.2 Scale out
   1.8.2.1 Load Balancing
1.8.3 Scale Within

The Scalability evaluation determines general areas of a system that are typical in addressing the scalability of a system. Growth is the increased demand on the system. This can be in the form of increased connections via users, connected systems or dependent systems. Growth usually is measured by a few key indicators such as Max Transactions per Second (TPS), Max Concurrent Connections and Max Bandwidth Usage. These key indicators are derived from factors such as the number of users, user behavior and transaction behavior. These factors increase demand on a system which requires the system to scale. These key indicators are described below in Table 13 as a means of defining the measurements that directly relate to determining system scalability:

| Term | Definition |
|---|---|
| Max Transactions per | The number of requests to a system per second. |
| second (TPS) | Depending on the transactional architecture of |
| | an application, this could be translated into |
| | Messages per Second (MPS) if an application |
| | uses message queuing or Requests per Second |
| | (RPS) for web page requests for example. |
| Max Concurrent | The maximum number of connections to a system |
| Connections | at a given time. For web applications, this is |
| | normally a factor of TCP/IP connections to a web |
| | server that require a web user session. For |
| | message queuing architectures, this is normally |
| | dependent on the number of queue connections |
| | that the message queuing manager manages. |
| Max Bandwidth Usage | The maximum bytes the network layer must |
| | support at any given time. Another term |
| | is ‘data on wire’ which implies focus on the |
| | Transport Layer of an application's |
| | communication requirements. |

Scale up refers to focusing on implementing more powerful hardware to a system. If a system supports a scale up strategy, then it may potentially be a single point of failure. The evaluator should determine whether scale up is available or required. If a system provides greater performance efficiency as demand increases (up to a certain point of course), then the system provides good scale up support. For example, middleware technology such as COM+ can deliver excellent scale up support for a system.

Scale out is inherently modular and formed by a cluster of computers. Scaling out such a system means adding one or more additional computers to the network. Couple scale out with layered application architecture provides scale out support for a specific application layer where it is needed. The evaluator should determine whether scale out is appropriate or required

An important tool for providing scale out application architectures is load balancing. Load balancing is the ability to add additional servers onto a network to share the demand of the system. The evaluator should determine whether load balancing is available and used appropriately. External resources available for the evaluator with respect to load balancing and available as a link or component of the toolset is Load-Balanced Cluster, http://msdn.microsoft.com/library/default.asp?url=/library/en-us/dnpatterns/html/DesLoadBalancedCluster.asp

Another point of evaluation involves “scale-in” scenarios, where a system leverages service technology running on the host to provide system scalability. These technologies make use resources that are used to provide improved efficiencies of a system. Middleware technology is a common means of providing efficient use of resources allowing a system to scale within. This analysis includes evaluating Stateless Objects—Objects in the business and data tier do not retain state from subsequent requests—and Application Container Resources, including Connection Pooling, Thread Pooling, Shared Memory, Cluster Ability, Cluster Aware Technology, and Cluster application design.

Another quality aspect for evaluation is Usability. This attribute includes the following characteristics for evaluation:

1.9 Usability
1.9.1 Learnability
1.9.2 Efficiency
1.9.3 Memorability
1.9.4 Errors
1.9.5 Satisfaction

Usability can be defined as the measure of a user's ability to utilize a system effectively. (Clements, P; Kazman, R.; Klein, M. Evaluating Software Architectures Methods and Case Studies. Boston, Mass.: Addison-Wesley, 2002. Carnegie Mellon Software Engineering Institute (hereinafter “Clements 2002”)) or the ease with which a user can learn to operate, prepare inputs for, and interpret outputs of a system or component. [IEEE Std. 610.12] or a measure of how well users can take advantage of some system functionality. Usability is different from utility and is a measure of whether that functionality does what is needed. [Barbacci 2003]

The areas of usability which the evaluator should review and evaluate include learnability, efficiently, memorability, errors and satisfaction. External resources available for the evaluator with respect to instrumentation and available as a link or component of the toolset include Usability in Software Design,http://msdn.microsoft.com/library/default.asp?url=/library/en-us/dnwui/html/uidesign.asp.

Learnability is the measurement the system is easy to learn; novices can readily start getting some work done. [Barbacci 2003] One method of providing improved learnability is by providing a proactive Help Interface—help information that detects user-entry errors and provides relevant guidance/help to the user to fix the problem and tool tips.

Efficiency is the measurement of how efficient a system is to use; experts, for example, have a high level of productivity. [Barbacci 2003]. Memorability is the ease with which a system can be remembered; casual users should not have to learn everything every time. [Barbacci 2003] One method to improve memorability is the proper use of them within a system to visually differentiate between areas of a system.

Errors are the ease at which users can create errors in the system; users make few errors and can easily recover from them. [Barbacci 2003] One method of improving errors is by providing a proactive help interface. Satisfaction is how pleasant the application is to use; discretionary/optional users are satisfied when and like the system . [Barbacci 2003]

Often methods to improve satisfaction are single sign-on support and personalization.

Another quality attribute for evaluation is Reliability. Reliability is the ability of the system to keep operating over time. Reliability is usually measured by mean time to failure. [Bass 98]

This attribute includes the following characteristics for evaluation:

1.10 Reliability
1.10.1 Server Failover Support
1.10.2 Network Failover Support
1.10.3 System Failover Support
1.10.4 Business Continuity Plan (BCP) Linkage
   1.10.4.1 Data Loss
   1.10.4.2 Data Integrity or Data Correctness

External resources available for the evaluator with respect to reliability and available as a link or component of the toolset are listed in Table 14:

| Title | Reference Information |
|---|---|
| Designing for | http://msdn.microsoft.com/library/default.asp?url=/library/en-us/vsent7/html/vxconDesigningForReliability.asp |
| Reliability: | |
| Designing | |
| Distributed | |
| Applications with | |
| Visual Studio .NET | |
| Reliability | http://msdn.microsoft.com/library/default.asp?url=/library/en-us/vsent7/html/vxconReliabilityOverview.asp |
| Overview: | |
| Designing | |
| Distributed | |
| Applications with | |
| Visual Studio .NET | |
| Performance | http://msdn.microsoft.com/library/default.asp?url=/library/en-us/dnpatterns/html/EspPerformanceReliabilityPatternsCluster.asp |
| and Reliability | |
| Patterns | |

Ideally, systems should manage support for failover however a popular method of providing application reliability is through redundancy. That is, the system provides reliability by failing over to another server node to continue availability of the system. In evaluating reliability, the evaluator should review server failover support, network failover support, system failover support and business continuity plan (BCP) linkage.

The evaluator should determine whether the system provides server failover and if it is used appropriately for all application layers (e.g. Presentation, Business and Data layers). External resources available for the evaluator with respect to failover and available as a link or component of the toolset are listed in Table 15:

| Title | Reference Information |
|---|---|
| Designing for | http://msdn.microsoft.com/library/default.asp?url=/library/en-us/vsent7/html/vxconDesigningForReliability.asp |
| Reliability: | |
| Designing | |
| Distributed | |
| Applications with | |
| Visual Studio .NET | |
| Reliability Overview: | http://msdn.microsoft.com/library/default.asp?url=/library/en-us/vsent7/html/vxconReliabilityOverview.asp |
| Designing | |
| Distributed | |
| Applications with | |
| Visual Studio .NET | |
| Performance and | http://msdn.microsoft.com/library/default.asp?url=/library/en-us/dnpatterns/html/EspPerformanceReliabilityPatternsCluster.asp |
| Reliability | |
| Patterns | |
| Microsoft Application | http://www.microsoft.com/applicationcenter/ |
| Center 2000 | |

The evaluator should determine whether the system provides network failover and if it is used appropriately. Generally, redundant network resources is used a means of providing a reliable network. The evaluator should determine whether the system provides system failover to a disaster recovery site and if it is used appropriately. The evaluator should determine whether the system provides an appropriate linkage to failover features of the system's BCP. Data loss is a factor of the BCP. The evaluator should determine whether there is expected data loss, and if so, if it is consistent with the system architecture in a failover event. Data integrity relates to the actual values that are stored and used in one's system data structures. The system must exert deliberate control on every process that uses stored data to ensure the continued correctness of the information.

One can ensure data integrity through the careful implementation of several key concepts, including: Normalizing data; Defining business rules; providing referential integrity; and Validating the data. External resources available for the evaluator with respect to evaluating data integrity and available as a link or component of the toolset include Designing Distributed Applications with Visual Studio NET: Data Integrity http://msdn.microsoft.com/library/default.asp?url=/library/en-us/vsent7/html/vxcondataintegrity.asp

Another quality attribute for evaluation is Testability. Testability is the degree to which a system or component facilitates the establishment of test criteria and the performance of tests to determine whether those criteria have been met [IEEE 90]. Testing is the process of running a system with the intention of finding errors. Testing enhances the integrity of a system by detecting deviations in design and errors in the system. Testing aims at detecting error-prone areas. This helps in the prevention of errors in a system. Testing also adds value to the product by conforming to the user requirements. External resources available for the evaluator with respect to testability and available as a link or component of the toolset are listed in Table 16:

| Title | Reference Information |
|---|---|
| Testing Process | http://msdn.microsoft.com/library/default.asp?url=/library/en-us/dnentdevgen/html/testproc.asp |
| Visual Studio Analyzer: | http://msdn.microsoft.com/library/default.asp?url=/library/en-us/vsavs70/html/veoriVisualStudioAnalyzerInBetaPreview.asp |
| Visual Studio Analyzer | |
| Compuware QA Center | http://www.compuware.com/products/qacenter/default.htm |
| Mercury Interactive | http://www.mercury.com/us/ |

Another quality attribute for evaluation is a Test Environment and Production Environment Comparison. Ideally, the test environment should match that of the production environment to simulate every possible action the system performs. However, in practice due to funding constraints this is often not achievable. One should determine the gap between the test environment and the production environment. If one exists determine the risks involved in assuming when promoting a system from the test environment to the production environment. This attribute includes the following characteristics for evaluation:

1.12 Test Environment and Production Environment Comparison
1.12.1 Unit Testing
1.12.2 Customer Test
1.12.3 Stress Test
1.12.4 Exception Test
1.12.5 Failover
1.12.6 Function
1.12.7 Penetration
1.12.8 Usability
1.12.9 Performance
1.12.10 User Acceptance Testing
1.12.11 Pilot Testing
1.12.12 System
1.12.13 Regression
1.12.14 Code Coverage

The evaluator should determine whether the application provides the ability to perform unit testing. External resources available for the evaluator with respect to unit testing and available as a link or component of the toolset are listed in Table 17:

| Title | Reference Information |
|---|---|
| Project: NUnit .Net unit testing | http://sourceforge.net/projects/nunit/ |
| framework: Summary | |
| Visual Studio: Unit Testing | http://msdn.microsoft.com/library/default.asp?url=/library/en-us/vsent7/html/vxconunittesting.asp |

System owner tests confirm how the feature is supposed to work as experienced by the end user. [Newkirk 2004] The evaluator should determine whether system owner tests have been used properly. External resources available for the evaluator with respect to owner tests and available as a link or component of the toolset include the Framework for Integrated Test, http://fit.c2.com.

The evaluator should determine whether the system provides the ability to perform stress testing (a.k.a. load testing or capacity testing). External resources available for the evaluator with respect to stress testing and available as a link or component of the toolset include: How To: Use ACT to Test Performance and Scalability, http://msdn.microsoft.com/library/default.asp?url=/library/en-us/dnpag/html/scalenethowto10.asp

The evaluator should determine whether the system provides the ability to perform exception handling testing and whether the system provides the ability to perform failover testing. A tool for guidance in performing failover testing and available as a link or component of the toolset is Testing for Reliability: Designing Distributed Applications with Visual Studio NET (http://msdn.microsoft.com/library/default.asp?url=/library/en-us/vsent7/html/vxconReliabilityOverview.asp).

The evaluator should determine whether the system provides the ability to perform function testing. A tool for guidance in performing function testing is Compuware QA Center (http://www.compuware.com/products/qacenter/default.htm).

The evaluator should determine whether the system provides the ability to perform security penetration testing for security purposes and whether the system provides the ability to perform usability testing. A tool for guidance in performing usability testing is UI Guidelines vs. Usability Testing http://msdn.microsoft.com/library/default.asp?url=/library/en-us/dnwui/html/uiguide.asp.

The evaluator should determine whether the system provides the ability to perform performance testing. Often this includes Load Testing or Stress Testing. A tool for guidance in performing load testing is: How To: Use ACT to Test Performance and Scalability http://msdn.microsoft.com/library/default.asp?url=/library/en-us/dnpag/html/scalenethowto10.asp.

User Acceptance Testing involves having end users of the solution test their normal usage scenarios by using scenarios by using the solution in a lab environment. Its purpose is to get a representative group of users to validate that the solution meets their needs.

The evaluator should determine: whether the system provides the ability to perform use testing; whether the system provides the ability to perform pilot testing; whether the system provides the ability to perform end-to-end system testing during the build and stabilization phase; and whether the system provides a means for testing previous configurations of dependent components. A tool for guidance in performing testing previous configurations is: Visual Studio: Regression Testing http://msdn.microsoft.com/library/default.asp?url=/library/en-us/vsent7/html/vxconregressiontesting.asp

Code Coverage tools are commonly used to perform code coverage testing and typically use instrumentation as a means of building into an system ‘probes’ or bits of executable calls to an instrumentation capture mechanism. External resources available for the evaluator with respect to code coverage are listed in Table 18:

| Title | Reference Information |
|---|---|
| Compuware: Code | http://www.compuware.com/products/devpartner/1563_ena_html.htm |
| Coverage Analysis | |
| Bullseye Coverage | http://www.bullseye.com/ |

There are a number of ways to evaluate code coverage. One is to evaluate statement coverage, which measures whether each line of code is executed. Another way is Condition/Decision Coverage which measures whether every condition (e.g. if-else, switch, etc statements) is executes its encompassing decision [Chilenski, J.; Miller, S. Applicability of Modified Condition/Decision Coverage to Software Testing, Software Engineering Journal, September 1994, Vol. 9, No. 5, pp. 193-200, hereinafter “Chilenski 1994”]. Yet another is path Coverage which measures whether each of the possible paths in each function have been followed. Function Coverage measures whether each function has been tested. Finally, Table Coverage measures whether each entry in an array has been referenced.

Another method of providing code coverage is to implement tracing in the system. In Microsoft .NET Framework, the System.Diagnostics namespace includes classes that provide trace support. The trace and debug classes within this namespace include static methods that can be used to instrument one's code and gather information about code execution paths and code coverage. Tracing can also be used to provide performance statistics. To use these classes, one must define either the TRACE or DEBUG symbols, either within one's code (using #define), or using the compiler command line.

Another quality attribute for evaluation is Technology Alignment. The evaluator should determine whether the system could leverage platform services or third party packages appropriately. Technology alignment is determined by the following: Optimized use of native operating system features; use of “off-the-shelf” features of the operating system and other core products; and architecture principle used

Another quality attribute for evaluation is System Documentation. This attribute includes the following characteristics for evaluation:

1.14 Documentation
1.14.1 Help and Training
1.14.2 System-specific Project Documentation
   1.14.2.1 Functional Specification
   1.14.2.2 Requirements
   1.14.2.3 Issues and Risks
   1.14.2.4 Conceptual Design
   1.14.2.5 Logical Design
   1.14.2.6 Physical Design
   1.14.2.7 Traceability
   1.14.2.8 Threat Model

The evaluator should determine whether the help documentation is appropriate. Determine if system training documentation is appropriate. Help documentation is aimed at the user and user support resources to assist in troubleshooting system specific issues commonly at the business process and user interface functional areas of a system. System training documentation assists several key stakeholders of a system such as operational support, system support and business user resources.

The evaluator should determine whether System-specific Project Documentation is present and utilized correctly. This includes documentation that relates to the system and not the project to build it. Therefore, the documents that are worthy of review are those used as a means of determining the quality of the system not the project. For example, a project plan is important for executing a software development project but is not important for performing a system review. In one example, Microsoft follows the Microsoft Solutions Framework (MSF) as a project framework for delivering software solutions. The names of documents will change from MSF to other project lifecycle frameworks or methodologies but there are often overlaps in the documents and their purpose. This section identifies documents and defines them in an attempt to try and map them to the system documentation which is being reviewed.

One type of documents for review is a functional specification—a composite of different documents with the purpose of describing the features and functions of the system. Typically, a functional specification includes:
Vision Scope summary. Summarizes the vision/scope document as agreed upon.
Background information. Places the solution in a business context.
Design goals. Specifies the key design goals that development uses to make decisions.
Usage scenarios. Describes the users' business problems in the context of their environment.
Features and services. Defines the functionality that the solution delivers.
Component specification. Defines the products that will are used to deliver required features and services as well as the specific instances where the products are used.
Dependencies. Identifies the external system dependencies of the solution.
Appendices. Other enterprise architecture documents and supporting design documentation.

The evaluator should determine: whether the requirements (functional, non-functional, use cases, report definitions, etc) are clearly documented.; whether the risks and issues active are appropriate; whether a conceptual design exists which describes the fundamental features of the solution and identify the interaction points with external entities such as other systems or user groups; whether a logical design exists which describes the breakdown of the solution into its logical system components; whether the physical design documentation is appropriate; and whether there is a simple means for mapping business objectives to requirements to design documentation to system implementation.

The evaluator should determine whether a threat model exists and is appropriate. A Threat Model includes documentation of the security characteristics of the system and a list of rated threats. Resources available for the evaluator with respect to code coverage are listed in Table 19:

| Title | Reference Information |
|---|---|
| Chapter 3 - Threat | http://msdn.microsoft.com/library/default.asp?url=/library/en-us/dnnetsec/html/THCMCh03.asp |
| Modeling (PAG) | |
| Threat Modeling Tool | \\internal link to software tool |
| v.1.0 | |

It should be noted that in Table 19 the Threat Modeling Tool link is an example of a link to an internal tool for the reviewer. It should be further understood that such a link, when provided in an application program or as a Web link, can immediately launch the applicable tool or program.

A supplemental area to the system review is the ability for the system support team to support it. One method of addressing this issue is to determine if the system support team's readiness. There are several strategies to identify readiness. This section defines the areas of the team that should be reviewed but relies on the system reviewer to determine the quality level for each area to formulate whether the system support team has the necessary skills to support the system.

The readiness areas that a system support team must address include critical situation, system architecture, developer tools, developer languages, debugger tools, package subject matter experts, security and testing.

There should be processes in place to organize the necessary leadership to drive the quick resolution of a critical situation. Critical situation events require the appropriate decision makers involved and system subject matter experts in the System Architecture and the relative system support tools.

The evaluator should determine if the appropriate subject matter experts exist to properly participate in a critical situation event.

The system architecture is the first place to start when making design changes. The evaluator should determine the appropriate skill level for the developer languages is necessary to support a system. The evaluator should determine if there are adequate resources with the appropriate level of familiarity with the debugger tools needed to support a system. If packages are used in the system, the evaluator should determine if resources exist that have the appropriate level of skill with the software package.

Any change to a system must pass a security review. Ensure that there exists the appropriate level of skilled resources to ensure that any change to a system does not result in increased vulnerabilities. Every change must undergo testing. The evaluator should ensure that there is an appropriate level of skill to properly test changes to the system.

The tools provided in the Toolset provide a way to quickly assist an application review activity. This includes a set of templates which provide a presentation of a review deliverable.

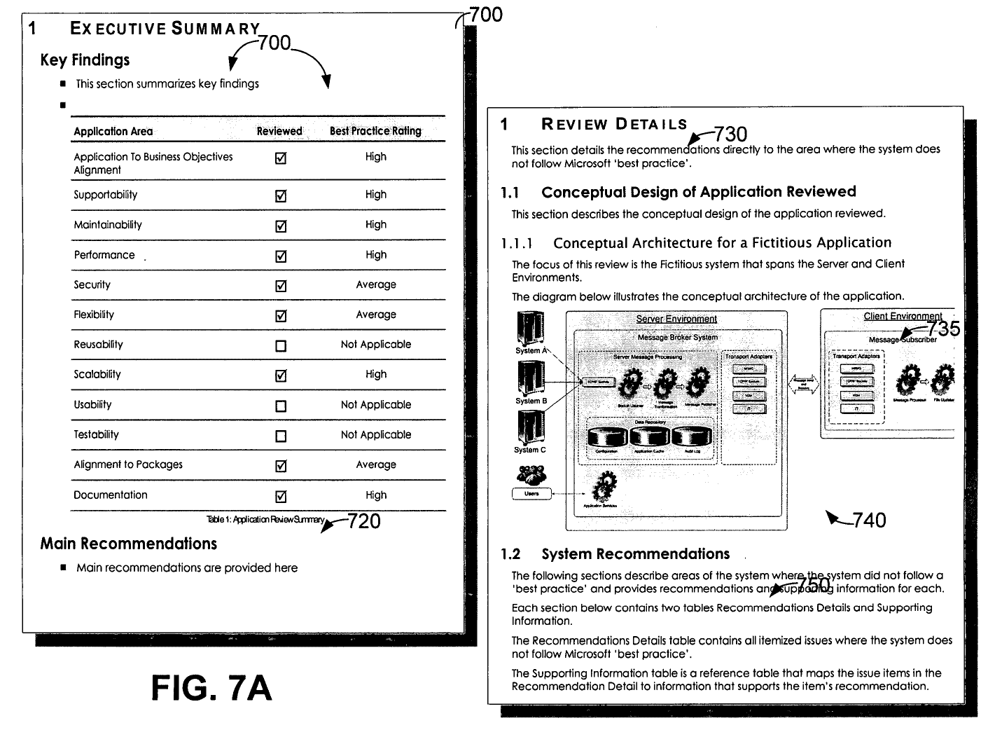

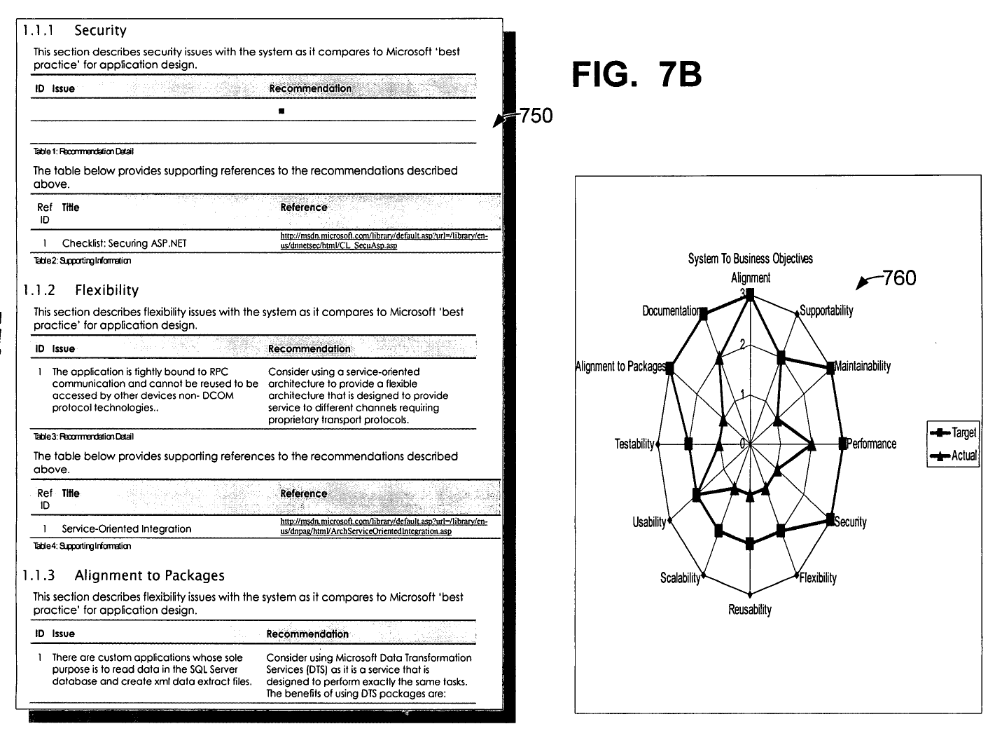

FIGS. 7A and 7B illustrate a deliverables template 700 which may be provided by the toolset. FIGS. 7A and 7B illustrate four pages of a deliverable having a “key finding” section and an Executive Summary 710, a Main Recommendations Section 720 and a Review Details section 730. The Executive summary and key findings section 710 illustrated the system review context as well as provides a rating based on the scale shown in Table 1. The main recommendations section includes recommendations from the evaluator to improve the best practices rating shown in section 710. The review details section 730 includes a conceptual design 735 of application reviewed, system recommendations 750 based on the evaluated quality attributes and a radar diagram. The end deliverable to the system owner may also include a radar diagram illustrating the design to implementation comparison resulting from the gain context step 32 of FIG. 3. It includes the system owner's expected rating of the system represented as the “Target” as well as the actual rating represented as “Actual”.

FIG. 8 illustrates a method for returning information to the toolset, and for performing step 16 of FIG. 1. As noted above, the feedback step 16 may be a modification of the quality attribute set, or stored content to be included in a deliverable such as that provided by the toolset template of FIGS. 7A and 7B. At step 40, content from an analysis provides new content for use in a deliverable. At step 42, a review is made by, for example, the reviewer who prepared the new content and a determination that the new content should be included in content samples made available for future deliverables is made. At step 44, the new content is stored in a data store, such as template 440 or data store 550, for use in subsequently generated deliverables. Optionally, at step 46, the quality attribute set may be modified.

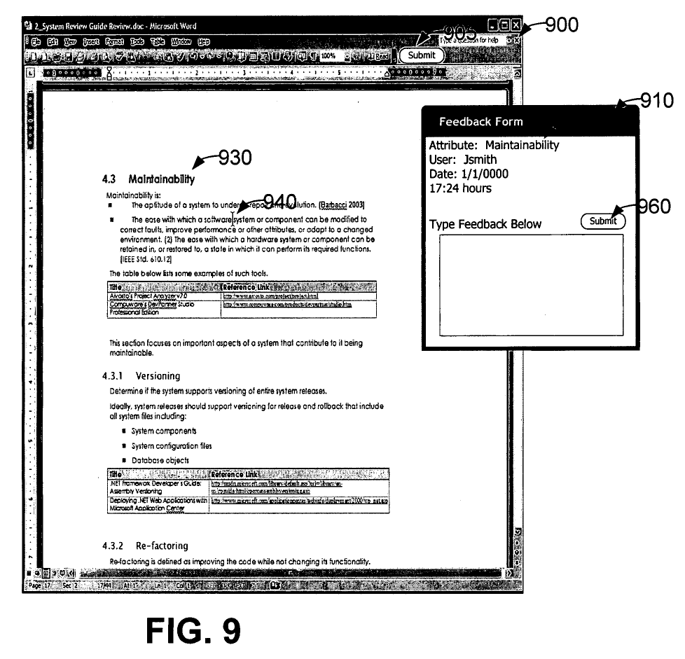

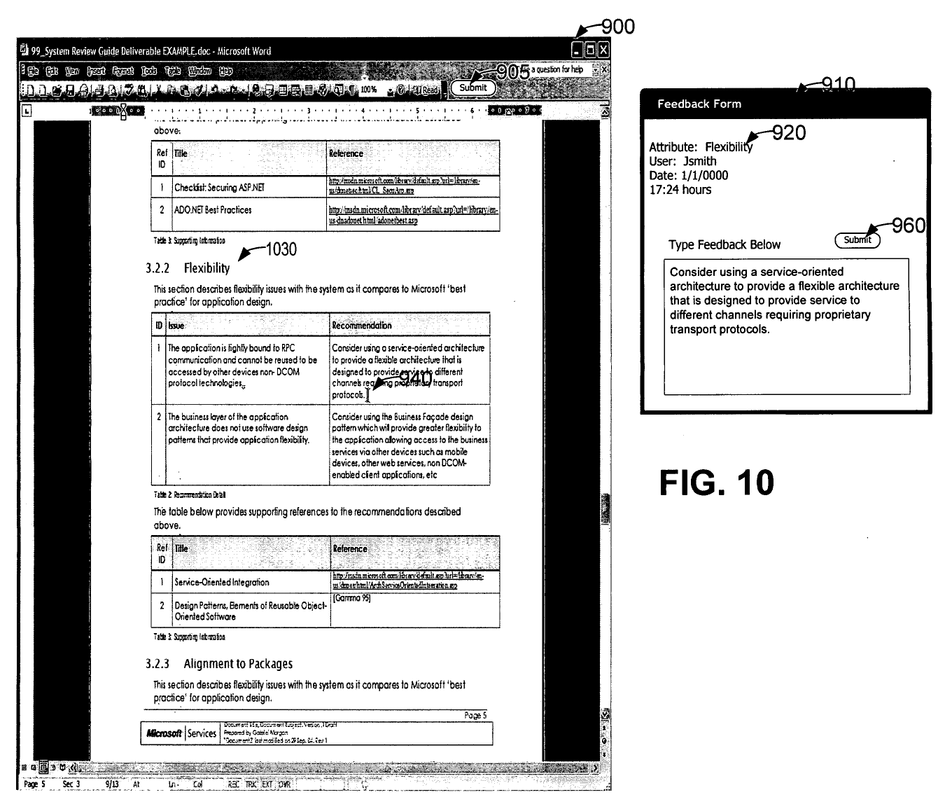

FIGS. 9 and 10 illustrate two various feedback mechanisms where the toolkit is provided as a document in, for example, a word processing program such as Microsoft® Word. In FIG. 9, a word processing user interface 900 is illustrated. A “submit” button, enabled as an “add in” feature of word allows the user to submit feedback in a toolkit document expressed in the word processing program. Depending on the position of the cursor 940, dialogue window 910 is generated with a set of information when the user clicks the “submit” button 905. The evaluator of the document finds a section 930 where they would like to provide feedback to the owners of the tool. The evaluator sets the cursor 940 in the section of interest. The evaluator clicks on a button 905 located in the toolbar, or in an alternative embodiment, “right-clicks” on a mouse to generate a pop up menu from which a selection such as “provide feedback” can be made. A dialogue box 910 appears with default information 920 such as; system attribute the user's cursor resides, date/time, author etc already populated. Next, the evaluator types their feedback such as notes on modifying existing content in a free form text box. Finally, the evaluator clicks the Submit button 960 on the dialogue window.

FIG. 10 illustrates an alternative embodiment wherein text from a deliverables document is submitted in a similar manner. In this case, the evaluator has positioned the cursor 940 in a section 1030 of a deliverables document. When the submit button 905 is selected, the pop-up window 910 is further populated with the evaluator's analysis to allow the new content to be returned to the toolkit owner, along with any additional content or notes from the evaluator.

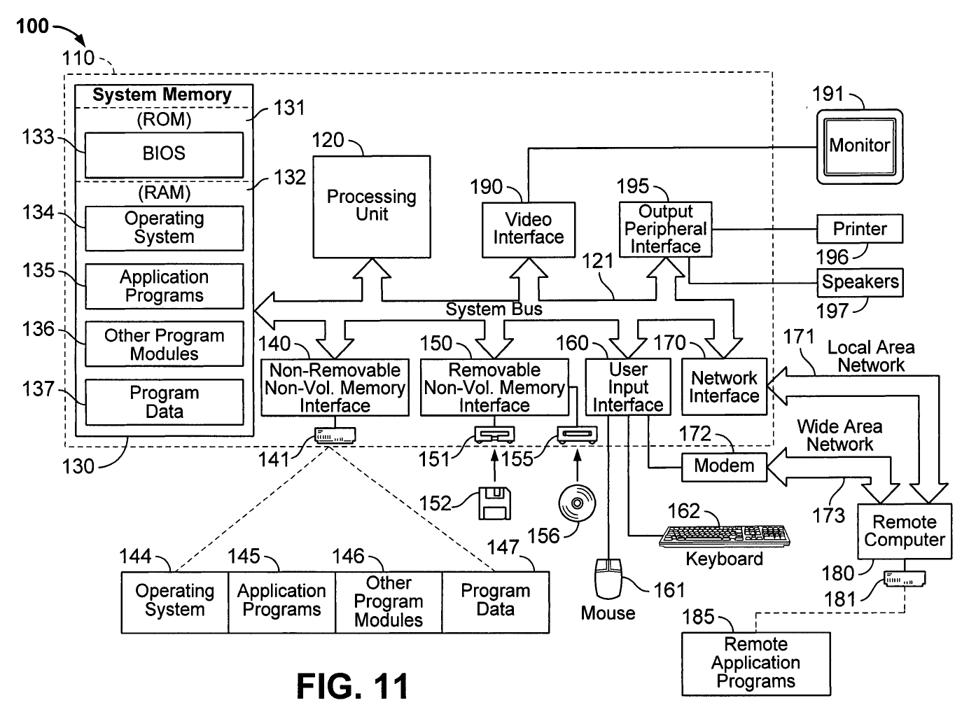

FIG. 11 illustrates an example of a suitable computing system environment 100 on which the invention may be implemented. The computing system environment 100 is only one example of a suitable computing environment such as devices 500, 510, and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 9 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 11, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 9 illustrates remote application programs 185 as residing on memory device 181. It will be appreciated that the network connections shown are exemplary and other means of establishing a communications link between the computers may be used.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for performing a system analysis, comprising:
selecting a set of quality attributes each having at least one aspect for review;
reviewing a system according to defined characteristics of the attribute; and
providing a system deliverable analyzing the system according to the set of quality attributes.

2. The method of claim 1 further including the step, prior to the step of collecting, of providing definitions for quality attributes and guidelines for evaluating each quality attribute.

3. The method of claim 2 further including the step of modifying the attributes or guidelines subsequent to said step of providing.

4. The method of claim 1 wherein the set of quality attributes includes at least one of the set of attributes including: System To Business Objectives Alignment; Supportability; Maintainability; Performance; Security; Flexibility; Reusability; Scalability; Usability; Testability; Alignment to Packages; or Documentation.

5. The method of claim 1 wherein the step of selecting includes determining a priority of the set of quality attributes and selecting the set based on said priority.

6. The method of claim 1 wherein the step of providing a deliverable includes generating a deliverable from a deliverable template and incorporating sample content from a previously provided deliverable.

7. The method of claim 6 wherein the step of providing a deliverable includes generating new content based on step of reviewing and returning a portion of said new content to a data store of content for use in said providing step.

8. The method of claim 1 wherein the step of selecting includes determining system design elements.

9. The method of claim 8 wherein the system deliverable reflects highlights areas in the system not aligned with system design elements.

10. A toolset for performing a system analysis:
a set of quality attributes for analysis of the system;
for each quality attribute, a set of characteristics defining the attribute;
at least one external reference tool associated with at least a portion of the quality attributes; and
a deliverable template including a format.

11. The toolset of claim 10 wherein each of said set of quality attributes includes a definition

12. The toolset of claim 10 wherein each of said set of characteristics includes guidelines for evaluating said characteristic.

13. The toolset of claim 2 wherein the set of quality attributes includes at least one of the set of attributes including: System To Business Objectives Alignment; Supportability; Maintainability; Performance; Security; Flexibility; Reusability; Scalability; Usability; Testability; Alignment to Packages; or Documentation.

14. The toolset of claim 10 further including sample content for said deliverable template.

15. The toolset of claim 10 further including guidelines for evaluating system design intentions.

16. The toolset of claim 10 further including references to public tools available for reference in performing a system analysis relative to at least one of said quality attributes.

17. The toolset of claim 10 further including references to public information available for reference in performing a system analysis relative to at least one of said quality attributes.

18. A method for creating a system analysis deliverable, comprising:
positioning a system analysis by selecting a subset of quality attributes from a set of quality attributes, each having a definition and at least one characteristic for evaluation;
evaluating the system by examining the system relative to the definition and characteristics of each quality attribute in the subset;
generating a report reflecting the system analysis based on said step of evaluating; and
modifying a characteristic of a quality attribute to include at least a portion of said report.

19. The method of claim 18 wherein the step of positioning includes ranking the set of quality attributes according to input from a system owner.

20. The method of claim 18 wherein the step of evaluating includes the steps of ensuring access to elements of the system to be evaluated, gaining context of the system relative to a system design specification, examining the characteristics of each of the subset of quality attributes, and evaluating the characteristics.
